(19) United States
(12) Patent Application Publication
(10) Pub. No.: US 2009/0125499 A1
(43) Pub. Date: May 14, 2009

(54) MACHINE-MODERATED MOBILE SOCIAL NETWORKING FOR MANAGING QUERIES

(75) Inventors: Karen M. Cross, Mountain View, CA (US); Lisa J. Stifelman, Palo Alto, CA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/938,125

(22) Filed: Nov. 9, 2007

(51) Int. Cl. G06F 17/30; G06F 17/00

(52) U.S. Cl. 707/5; 707/104.1; 707/E17.017; 707/E17.001

(57) ABSTRACT

Systems and methods of a machine-moderated mobile social networking for managing queries are disclosed here. In one aspect, embodiments of the present disclosure include a method, which may be implemented on a system, of receiving queries from a mobile device and intelligently distributing the queries among users that are deemed suitable to provide useful insight to the queries. The queries are typically questions asked by potential patrons regarding specific venues, patrons looking for specific businesses and/or events that fit their specific criteria, by way of example but not limitation, geography, locale, type of cuisine, ambience, music, etc. In most instances, a consumer can send the query from a portable device (e.g., cell phone, Blackberry, telephone, iPhone, Treo, etc.) in various formats (e.g., SMS text, voice call, USSD message, IM, and/or email, etc.) to a predetermined phone number and/or other types of address identifiers.

### BACKGROUND

Community-based peer review networks permit consumers to review un-biased ratings and/or user comments about personal experiences of others at a place of business (e.g., restaurant, bar, diner, café, tea shop, library, dry cleaners, pizza delivery, etc.), community-based venues and/or events (e.g., arts and crafts festival, opera, performing arts theatre, state fair, farmer's market, jazz festival, etc.). Existing peer-review networks include web-based location specific forums (e.g., Yelp.com, CitySearch.com, Epinions.com, Metroactive.com, etc.) that enable consumers to submit ratings and/or provide comments describing personalized experience there, if so desired.

For example, in addition to quantitative ratings, consumers can comment on whether the pricing is reasonable, whether the ambience was suitable/desired (e.g., music, lighting, noise level), the quality of the service, friendliness of staff, knowledge level of the staff about their offerings, promptness, freshness of the food, and/or in many instances, specific comments about particular dishes and/or other specialties. Consumers can further describe experiences with a particular event or a venue. For example, comments can be provided for a production company that tours the U.S., a jazz festival that occurs locally once a year, etc. General reviews about the venue, visibility, acoustics, quality of the artists, lighting, staging, etc. can be provided.

The web-based peer-review networks provide a facility for potential patrons to narrow a set of options or as a source of additional selections that were previously unaware to the potential patron. For example, if the potential patron was eyeing a particular Middle-Eastern Cuisine restaurant, specific user experiences can be factored in by reviewing the comments that the restaurant has received prior to deciding to frequent the business.

However, web-based peer-review networks typically are of utility when accessible via non-portable devices. In addition, web-based peer-review networks typically provide a pathway for one to read other's comments, rather than to solicit personalized responses from other users regarding their personal experiences with specific businesses, listings, and/or events, for example.

While web-based peer-review networks are, in some instances, depositories of personal experiences and potential patrons can sometimes determine from descriptions of personal experiences of others whether they would have a pleasant experience, the potential patrons may not be able to ask a member of the community, specific questions, such as, “where can I get the best French press coffee in town”. If the question is posted on a forum, a response may not be received for many days. Furthermore, oftentimes, queries regarding business queries are relevant to those residing or those that frequently visit a particular locale/geographical region. Community-based peer review systems typically do not provide a channel for queries to be distributed based on the particular relevant locale/geographical location.

Additionally, while web-sites of various businesses and events can provide extensive information about offerings, hours of operation, and/or in some instances, professional reviews (e.g., by Zagat, New York Times, Wine Spectator, etc.), this information is accessed via the web and when the user has Internet connectivity. The consumer may also need to know the name of the place of business and the URL to access business information. Furthermore, the professional reviews provided by businesses on their website, are often biased and oftentimes, do not provide useful insights to questions about personal experiences a potential consumer may have.

There are also many well-known question-and-answer services (e.g., Yahoo Answers, Google Answers, etc.).

### SUMMARY

Systems and methods of machine-moderated mobile social networking for managing queries are described here. Some embodiments of the present disclosure are summarized in this section.

In one aspect, embodiments of the present disclosure include a method, which may be implemented on a system, of receiving queries from a mobile device and intelligently distributing the queries among users that are deemed suitable to provide useful insight to the queries.

The queries are typically questions asked by potential patrons regarding specific venues, patrons looking for specific businesses and/or events that fit their specific criteria, by way of example but not limitation, geography, locale, type of cuisine, ambience, music, etc. In most instances, a consumer can send the query from a portable device (e.g., cell phone, Blackberry, telephone, iPhone, Treo, etc.) in various formats (e.g., SMS text, voice call, USSD message, IM, and/or email, etc.) to a predetermined phone number and/or other types of address identifiers.

For example, a tourist visiting San Francisco can submit a query looking for the best breakfast crepes with extra fruit toppings within a 10 mile radius of the tourist's current location. Similarly, the tourist may specify to look for the best breakfast crepes with extra fruit toppings in the Mission district of San Francisco. Consumers can also specify queries about specific types of events, such as, for live jazz after 10 PM on weekends. In some embodiments, the query is initially scanned for indicators of search parameters to determine a set of criteria that a set of suitable recipient users would possess. Indicators of search parameters in a query can typically be identified from references to a specific neighborhood/locale (“the Mission district”), specific distances (e.g., 10 mile radius), a time (e.g., after 10 PM, weekend), a type of business/cuisine (e.g., breakfast), a type of event (e.g., live jazz), and/or a specific business listing (e.g., IHOP).

The search parameters facilitate identification of recipient users that are suitable for providing a useful response (e.g., personalized responses) to queries submitted by potential customers and/or patrons. In one embodiment, a cross comparison is made between user profiles and the indicators of search parameters (e.g., neighborhood, geography, distance, time, cuisine, event, etc.) to identify potential matches. For example, a user profile (e.g., user data, user metadata, user information, etc.) may indicate that specific sets of potential recipient users live in or around the Mission. In addition, user profiles may indicate that particular users are particularly fond of breakfast crepes. Similarly, users may indicate that they are jazz fans. Thus, these recipient users would initially be deemed suitable for generating useful responses (personalized responses) that provide insight to user queries, for example.

In a further aspect of the present disclosure, the suitable set of recipient users to whom a query is to be distributed to is further narrowed based on criteria specified by the recipient users.

For example, some recipients may have indicated that they would prefer to receive queries between noon-5 PM while some recipients may prefer to receive queries between 4 PM and 9 PM. Criteria can also be specified in other formats as well, by way of example but not limitation, recipients may specify preferences for receiving queries about certain types of cuisine, queries to certain geographical regions, and/or certain types of events, etc. Therefore, based on a combination of system identified suitability and self-specified criteria, at least one recipient user can be selected from the set of suitable recipient users.

The query can be provided to the selected users via a number of communications channels, including but not limited to, via SMS text, via a voice call (e.g., automated or manual) to a cell phone or a landline phone, via an instant message, via email, via voice mail, via a message to a web-based portal, etc. Responses provided by the selected users are received by the system prior to distribution back to the user that submitted the query. The system, can, in some embodiments, filter through the responses provided by the recipient users and remove the ones that appear to be irrelevant or otherwise out of context. When a predetermined number of responses have been received (e.g., predetermined by the requesting user, predetermined by the system, adaptively determined based on time of day, type of query, etc.), the system processes the responses prior to generating enhanced responses for the requesting user.

In accordance with further embodiments of the present disclosure, business data relevant to responses provided by the recipient users are identified and assimilated with the responses to be provided to the requesting user as enhanced responses.

Relevant business data is, in some embodiments, identified based on specific types of parameters in responses provided by recipient users. For example, a specific type of parameter can include the name of a business (e.g., Taco Bells, Superb Breakfast Crepes, etc.), the name of an event (e.g., SF Jazz Festival), etc. Based on the specific parameters, business listing information can be identified and provided in conjunction to the requesting user. Business listing information can include, for example, hours of operation, address, phone number, email, offerings, tickets information, price of event, etc.

Since the recipient user responding to the query may not always have specific business listing information (e.g., business data) handy, thus, generating an enhanced response by assimilating the personalized response with business data (e.g., hours of operation and address) to be provided to the requesting user can be useful, in particular, for one that is on-the-go or otherwise traveling. In some embodiments, maps of the business listing and/or event are provided to the requesting user in addition to the address, for example.

Business data may include any of a wide variety of different parameters. For example, business data may include data provided in association with a service. For example, a request for a personalized response regarding a music download could be made. Such a request might include the name of a band, an artist, a song, a recording date, etc. and a question, such as whether the band is any good. A download of the music in question could be provided to the user, if the user decides to act on a recommendation.

In one aspect, embodiments of the present disclosure include a method, which may be implemented on a system, of a portable device enabled peer review system for responses to queries.

In some embodiments, when identifying recipient users to distribute queries to, the system can consider various quantitative and/or qualitative data related to historical responses that recipient users have provided as well as response behavior. For example, the peer review system can provide an avenue through which users (e.g., responding users and/or requesting users) can review responses provided by other users and comment on utility of the responses. In addition, a quantitative ratings system can be provided in addition to or in lieu of the comment fields. In some embodiments, quantitative data (e.g., statistical data) regarding responsiveness of recipient users can be measured, analyzed, and/or recorded. Some of the quantitative data describing responsiveness include, average time to response, rate of response (e.g., number of responses provided to number of queries received ratio), total number of responses, average rating, etc. The quantitative and/or qualitative measures regarding quality and/or promptness of responses provide an additional measure through which to identify recipient users to whom to present user queries. The quality/promptness measures provide in addition to user motivation, a pathway to control/enhance the caliber of responses and thus, improve user usability and friendliness, and therefore, potentially increasing usage to facilitate expansion of the viral network to further enrich user experiences with the mobile social network.

The present disclosure includes methods and systems which perform these methods, including processing systems which perform these methods, and computer readable media which when executed on processing systems cause the systems to perform these methods.

Other features of the present disclosure will be apparent from the accompanying drawings and from the detailed description which follows.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates a block diagram of a plurality of client devices coupled to one another and a host server that manages queries by moderating mobile social networking among users of the plurality of client devices via one or more of a mobile wireless network, telephone network, and/or network, according to one embodiment.

FIG. 2A depicts a block diagram illustrating a system to moderate mobile social networking for query management among a plurality of users, the system to include a host server coupled to a user database and/or a listings database, according to one embodiment.

FIG. 2B is a diagrammatic view illustrating the progression of a query into a response among varying entities in a mobile social networking environment, according to one embodiment.

FIG. 3A depicts a block diagram illustrating a user database to store user profiles, user ratings/reviews, and/or queries/enhanced responses, according to one embodiment.

FIG. 3B depicts a block diagram illustrating a listings database to store business listings and/or events listings, according to one embodiment.

FIG. 4 illustrates example user interfaces for a user to submit a query via SMS and to receive machine-moderated human responses, according to one embodiment.

FIG. 5 illustrates a series of example user interfaces for a portable device user to submit a query and to specify the audience to direct the query to, according to one embodiment.

FIG. 6A illustrates a series of example user interfaces for a portable device user to submit a recommendations in response to a query, according to one embodiment.

FIG. 6B illustrates a series of example user interfaces for a portable device user to provide recommendations in response to a query via SMS, according to one embodiment.

FIG. 7A illustrates a series of example user interfaces for a user to access and view the moderated enhanced responses provided in response to a query submitted by the user, according to one embodiment.

FIG. 7B illustrates a series of example user interfaces for a user to access and view the moderated enhanced responses provided in response to a query submitted by the user, according to one embodiment.

FIG. 8A depicts a flow diagram illustrating a process of providing a query to a recipient to respond to the query, according to one embodiment.

FIG. 8B depicts a table illustrating examples of user specified criteria, according to one embodiment.

FIG. 8C depicts a flow diagram illustrating a process of providing enhanced responses to a requesting user, according to one embodiment.

FIG. 9 depicts a flow diagram illustrating a process of a community-based peer review system for responses to queries, according to one embodiment.

FIG. 10 shows a diagrammatic representation of a machine in the example form of a computer system within which a set of instructions, for causing the machine to perform any one or more of the methodologies discussed herein, may be executed, according to one embodiment.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

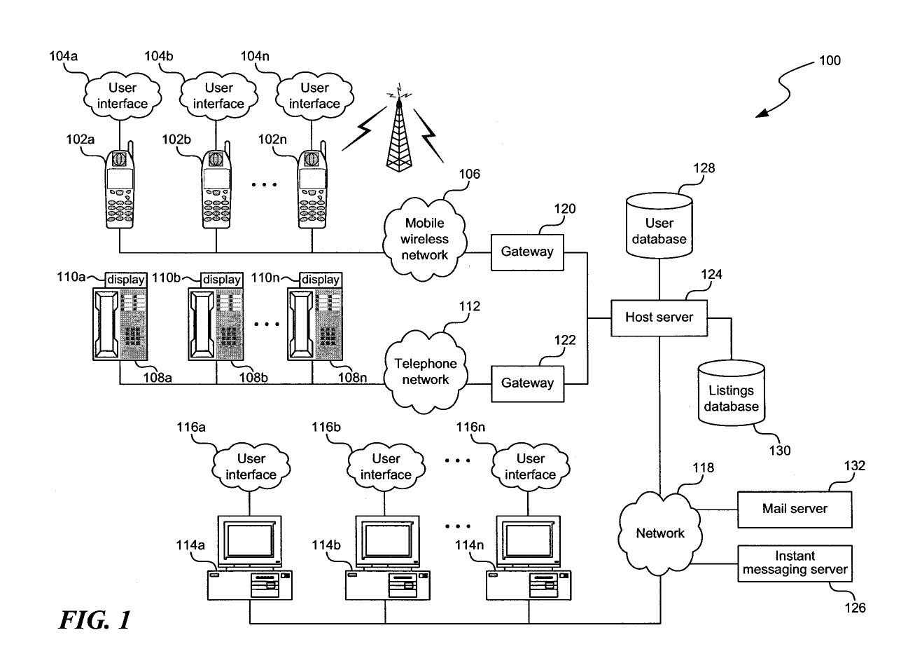

FIG. 1 illustrates a block diagram of a plurality of client devices 102A-N, 108A-N, 114A-N coupled to one another and a host server 124 that manages queries by moderating mobile social networking among users of the plurality of client devices via one or more of a mobile wireless network 106, telephone network 112, and/or network 118, according to one embodiment.

The plurality of client devices (e.g., mobile devices) 102A-N can be any system and/or device, and/or any combination of devices/systems that is able to establish a connection with a wireless network (e.g., mobile wireless network 106). The mobile devices 102A-N typically include a screen or other output display functionalities to present data exchanged between the devices to a user, such as to display user interfaces 104A-N. For example, the mobile devices 102A-N can be, but are not limited to, a mobile computing device, a mobile phone, a cellular phone, a VoIP phone, a smart phone, a PDA, a Blackberry device, a Treo, and/or an iPhone, etc.

The plurality of telephonic devices 108A-N can be any system and/or device, and/or any combination of devices/systems that is able to establish a connection with a telephone network 112. The telephonic devices 108A-N typically include a screen 110A-N or other output display functionalities to present data exchanged between the devices to a user, such as to display system or call status. For example, the mobile devices 102A-N can be, but are not limited to, a wired or wireless telephone, a fax machine, an answering machine, mobile phone, a cellular phone, a landline phone, a satellite phone, a PBX phone, a VoIP phone, a smart phone, a PDA, a Blackberry device, a Treo, an iPhone, and/or any other type of communication device able to provide voice communication and/or touch-tone signals over the telephone network 112. In addition, any audio signal carrying interface can be used.

The client devices 114A-N can be any system and/or device, and/or any combination of devices/systems that is able to establish a wired or wireless connection with another device, servers and/or other systems in some instances via a network (e.g., network 118). The client devices 114A-N may also include a screen or other output display functionalities to present data exchanged between the devices to a user, such as, to display user interfaces 116A-N. For example, the client devices 114A-N can be, but are not limited to, a processing unit, a server desktop, a desktop computer, a computer cluster, a mobile computing device such as a notebook, a laptop computer, a handheld computer, a mobile phone, a smart phone, a PDA, a Blackberry device, a VoIP phone, a Treo, and/or an iPhone, etc.

In one embodiment, the mobile devices 102A-N, the telephonic devices 108A-N and client devices 114A-N are coupled via a mobile wireless network 106, gateways 120/122 and the network 118. The host server 124 can be coupled to the mobile devices 102, telephonic devices 108, and the client devices 114 via one or more of the mobile wireless network 106, the telephone network 112, and the network 118.

For example, the wireless network (e.g., mobile wireless network) 106 can be any network able to establish connections with mobile devices 102A-N, such as mobile phones. The wireless network 110 can be, but is not limited to Global System for Mobile Communications (GSM) network, Code Division Multiple Access (CDMA) network, Evolution-Data Optimized (EV-DO) network, Enhanced Data Rates for GSM Evolution (EDGE) network, 3GSM network, Fixed Wireless Data, 2G, 2.5G, 3G networks, enhanced data rates for GSM evolution (EDGE) network, General packet radio service (GPRS) network, enhanced GPRS network, Digital Enhanced Cordless Telecommunications (DECT), Digital AMPS (IS-136/TDMA) network, and Integrated Digital Enhanced Network (iDEN).

GSM networks typically provide wireless service providers with the ability to offer roaming services to subscribers when they travel outside of the region (e.g., country) where subscription is based. Communication services provided by the wireless network 106 may further support messaging protocols such as, but is not limited to, Multimedia Messaging Service (MMS), SMS, USSD, IRC, or any other wireless data networks and/or messaging protocols.

In particular, GSM networks typically offer Short message service (SMS), or text messaging services to subscribers, thus allowing, for example, mobile device users (e.g., users of mobile devices 102A-N) to send text messages to one another. SMS is typically supported by mobile standards such as ANSI CDMA networks, 3G, AMPS, satellite, and/or landline networks. The Short Message Service—Point to Point (SMS-PP) is defined in the GSM recommendation 3GPP TS 23.040/3GPP TS 23.041 and is incorporated herein by reference.

In addition to messaging between mobile device users, messages (e.g., ads, public messages) can be broadcasted to mobile devices within a geographical region. SMS messages sent from a mobile device can be forwarded to Short Message Service Centers (SMS-C) which can store and/or forward the text message to a recipient. If the recipient mobile device cannot be reached or is not available, the SMS-C can store the message in a queue to be sent later. In some instances, the SMS-C attempts transmission once and does not store unsent messages in a queue for later retry. In some situations, a user may request delivery reports to receive a confirmation when a text message has been delivered to the receiving mobile device.

Typically, the transmission of text messages between the mobile device and the SMS-C is managed by the Mobile Application Part (MAP) of the SS7 protocol. The MAP specification is described in 3GPP TS 29.002 and the contents are incorporated herein by reference. MAP allows various communications networks (e.g., GSM, UMTS mobile core networks, GPRS core networks, etc.) to interact with one another to deliver services to mobile devices. In addition to SMS, the applications facilitated by MAP include, by way of example but not limitation, mobility services for location management and authentication, operation and maintenance, call handling, supplementary services, Packet Data Protocol (PDP) services for GPRS, and/or location service management services.

The SS7 protocol is a standard described by the ITU Telecommunication Standardization Sector (ITU-T) and includes functions such as, but is not limited to, Message Transfer Part (MTP) to provide transfer an delivery of signaling information across networks, Signaling Connection Control Point (SCCP) to provide routing capabilities via SubSystem Numbers (SSNs), ISDN User Part (ISUP) to provide transport of call set-up information between signaling points, Interconnect User Part (IUP) to support customer services and network features at point of interconnect between pubic networks, Transaction Capability Application Part (TCAP) to provide capability of transferring non-circuit-related information between signaling points, and Telephone User Part (TUP) to provide transport of call set-up information between signaling points for voice services, etc.

In addition, GSM provides Unstructured Supplementary Service Data (USSD) capabilities to mobile devices to support transmission of information over signaling channels of the GSM network. USSD is a communications technology that can be used to send data (e.g., text) between a mobile device and an application program in the network. USSD is defined in the GSM standard in GSM 02.90 (USSD Stage 1), GSM 03.90 (USSD Stage 2), and GSM 04.90; the contents are herein incorporated by reference. USSD Phase 1 in general supports mobile-initiated operations (as opposed to network-initiated operations).

Therefore, the mobile device can send a USSD command to the network and receive a response. In other words, a USSD Phase 1 communication session typically comprises one request and one answer (e.g., one USSD transaction). With USSD Phase 2, a dialogue can generally be established between the mobile device and the wireless network. Multiple USSD operations can typically be sent within a communication session. In addition, the dialogue with USSD Phase 2 can be network (application)-initiated or mobile station-initiated.

In most instances, USSD can provide a text-based, bidirectional, interactive, and session-oriented channel of communication between mobile devices and servers in the Home Public Land Mobile Network (HPLMN) and the Visited Public Land Mobile Network (VPLMN) of mobile subscribers. USSD messaging service is typically session-based thus resulting in faster response times compared to messaging services that are store-and-forward services such as SMS. Thus typically, once a USSD command/message has been sent to a service provider, a response can be received within a few seconds. In some applications, a USSD command is sent to query available balance and/or call logs in pre-paid GSM services. The mobile device user can, in some instances, communicate with a wireless application provided by the wireless service provider (e.g., operator) in a manner that is transparent to the mobile device and intermediate network entities.

The telephone network 112 can be any network able to establish connections with one or more telephone devices 108A-N through any known and/or convenient telephonic protocol. For example, the telephone network 112 can be, but is not limited to, the public switched telephone network (PSTN), the integrated services digital network (ISDN), asymmetric digital subscriber line (ADSL), digital subscriber line (DSL) and/or some other type of telephone network. The telephone network 112 generally represents an audio signal carrying network. Telephonic devices can digitally transmit speech, sound, touch-tone signals, and/or other types of data over the telephone line. The PSTN is largely governed by technical standards created by the ITU-T, and uses E.163/E.164 addressing and is incorporated herein by reference.

The network 118, over which the client devices 114A-N communicate, may be a telephonic network, an open network, such as the Internet, or a private network, such as an intranet and/or the extranet. In addition, the network through which IM servers (e.g., IM server 134) provide services to client devices may be a telephonic network, an open network, such as the Internet, or a private network, such as an intranet and/or the extranet.

The client devices 114-N can be coupled to the network (e.g., Internet) via a dial up connection, a digital subscriber loop (DSL, ADSL), cable modem, and/or other types of connection. Thus, the client devices 114A-N can communicate with remote servers (e.g., web server, host server, mail server, and/or instant messaging server) that provide access to visual interface to the World Wide Web via a web browser, for example.

For example, the Internet can provide file transfer, remote log in, email, news, RSS, and other services through any known and/or convenient protocol, such as, but is not limited to the TCP/IP protocol, Open System Interconnections (OSI), FTP, UPnP, iSCSI, NSF, ISDN, PDH, RS-232, SDH, SONET, etc. In some embodiments, the network 118 can be any collection of distinct networks operating wholly or partially in conjunction to provide connectivity to the client devices, host server, and/or the content providers 108A-N, 110 and may appear as one or more networks to the serviced systems and devices. In one embodiment, communications can be achieved by a secure communications protocol, such as secure sockets layer (SSL), or transport layer security (TLS).

In addition, communications can be achieved via one or more wired and/or wireless networks, such as, but is not limited to, one or more of a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), Bluetooth, Wi-Fi, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks or messaging protocols.

The gateways 120 and 122, typically interfaces the mobile wireless network 106 and the telephone network 112 to another network (e.g., network 118) that utilizes one or more different protocols. The gateways 120 and 122 can communicate with one or more components having any combination of software agents and/or hardware modules for facilitating a mobile device operator (e.g., a user of mobile devices 102A-102N) and the telephone operator (e.g., a user of telephone devices 108A-N) to communicate with a client device user (e.g., a user of client devices 108A-N) through a mobile wireless network (e.g., the wireless network 106), a telephone network (e.g., the telephone network 112), and the network 118.

The gateways 120 and 122 can include a number of components such as, but is not limited to, protocol transistors, impedance matching devices, rate converters, fault isolators, and/or signal translators, etc., to interface to one or more networks with different protocols than the protocols under which the original signal was sent. The gateways 120 and 122 can further facilitate the establishment of a set of rules and administrative procedures between different network protocols such that communication can be established. Typically, protocol converters such as gateways can operate at any network layer (e.g., the application layer, the presentation layer, the session layer, the transport layer, the network layer, the data link layer, and/or the physical layer) of the Open System Interconnection (OSI) model and convert one protocol stack into another. For example, a gateway can connect a LAN to the Internet. Similarly, gateways can also connect two IP-based networks.

In some embodiments, the gateways 120 and/or 122 are any combination of hardware modules and software agents able to convert an SMS message to the TCP/IP standard. In one embodiment, connection between the SMS-C and the Internet and/or other TCP/IP-based networks can be established via the SMPP protocol provided by the gateway. The gateway may further be connected to the IM server 134 through a TCP/IP network. In one embodiment, the gateway is connected to the IM server 134 via the XMPP protocol, which is typically compatible with real-time or near-real-time communications and managing presence information of subscribers.

RFC 821 published by the Internet Engineering Task Force (IETF) describes the Simple Mail Transport Protocol (SMTP) the contents of which are herein incorporated by reference. RFC 1459 published by IETF describes the Internet Relay Chat (IRC) protocol, a system for text-based conferencing in TCP/IP networks, the contents of which are herein incorporated by reference. RFC 3920, 3921, 3922 and 3923 published by IETF describe the Extensible Messaging and Presence Protocol (XMPP), a protocol for “instant messaging” (IM) applications in TCP/IP networks, the contents of which are herein incorporated by reference.

In one embodiment, the host server 124 is coupled to a mail server 132 over the network 118. The mail server 132 includes software agents and/or hardware modules for managing and transferring emails from one system to another, such as but is not limited to Sendmail, Postfix, Microsoft Exchange Server, Eudora, Novell NetMail, and/or IMail, etc. The mail server 132 can also store email messages received via the network. In one embodiment, the mail server 132 includes a storage component, a set of access rules which may be specified by users, a list of users and contact information of the users' friends, and/or communication modules able to communicate over a network with a predetermined set of communication protocols.

The user database 128 and listings database 130 can store software, descriptive data, images, system information, drivers, and/or any other data item utilized by other components of the host server 124 and/or the content server 126 for operation. The user database 128 and listings database 130 may be managed by a database management system (DBMS), for example but not limited to, Oracle, DB2, Microsoft Access, Microsoft SQL Server, PostgreSQL, MySQL, FileMaker, etc.

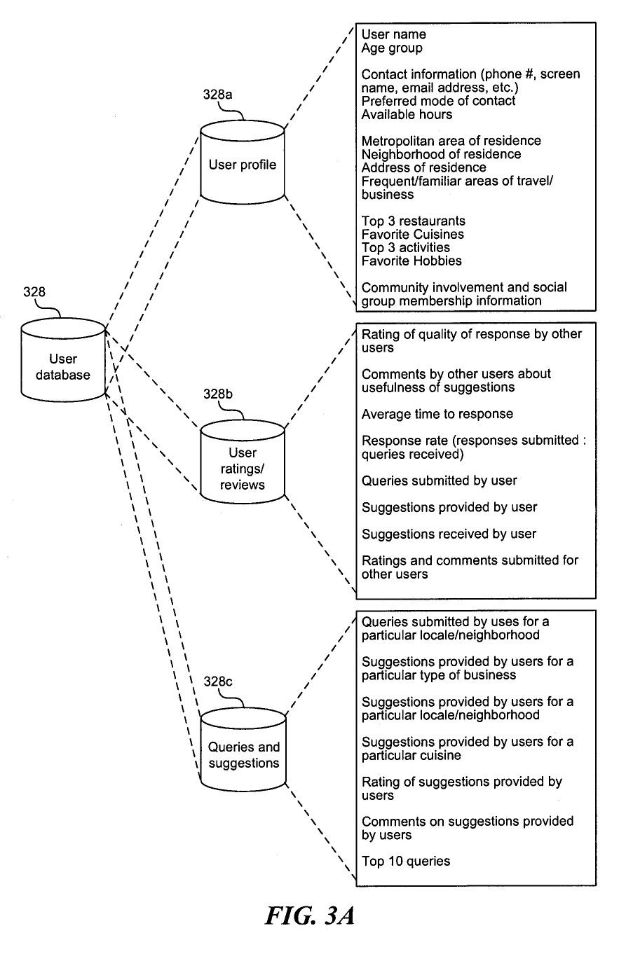

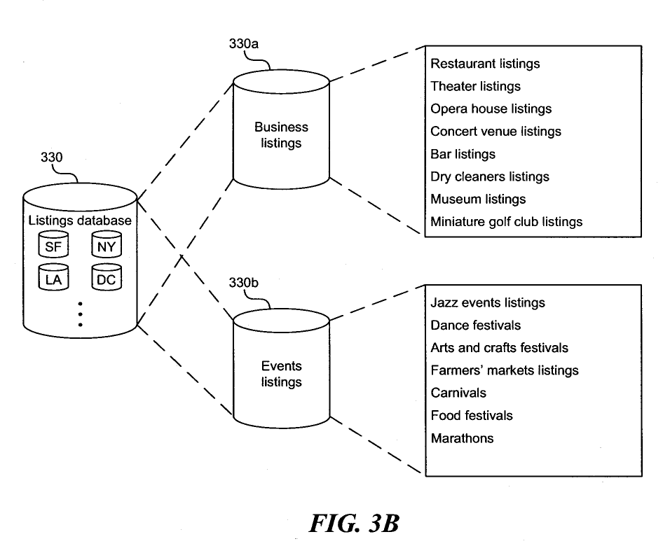

The databases 128 and 130 can be implemented via object-oriented technology and/or via text files, and can be managed by a distributed database management system, an object-oriented database management system (OODBMS) (e.g., ConceptBase, FastDB Main Memory Database Management System, JDOInstruments, ObjectDB, etc.), an object-relational database management system (ORDBMS) (e.g., Informix, OpenLink Virtuoso, VMDS, etc.), a file system, and/or any other convenient or known database management package. An example set of data to be stored in the user database 128 and listings database 130 is illustrated in FIG. 3A-3B.

The host server 124 is, in some embodiments, able to communicate with cell phone devices 102A-N via the mobile wireless network 106, telephone devices 108A-N via the telephone network 112, and/or client devices 114A-N via the network 118. In addition, the host server 124 is able to retrieve data from the user database 128 and/or the listings database 130. In some embodiments, the host server 124 assimilates data obtained from databases 128/130 to generate enhanced responses by combining user responses and business data to be provided a requesting user device, which can be the cell phone devices 102A-N, the telephone devices 108A-N, and/or the client devices 114A-N. In some embodiments, the host server 124 identifies data in the user database 128 to determine suitability of users to provide responses to a query.

The communications that the host server 124 establishes with the client-end devices can be multi-way and via one or more different protocols. Typically, a query is received from a requesting user via one communications channel within the duration of one communications session, although other possibilities are contemplated. Any number of communications sessions over any communications protocol may be established for sending queries to multiple recipient users. For example, the query may be sent to one recipient via SMS and the other via email.

In addition, the host server 124 can establish communication sessions with databases 128/130 to identify additional information about the users, such as, but not limited to reviews, ratings, quantitative data (e.g., rate of response, average time to response, etc.), preferences for receiving queries (e.g., time of day, number of queries to receive, frequency, etc.) and/or any other useful information which may indicate a user's specialized knowledge and/or quality of previous responses. The host server 124 may also obtain information about business listings via communicating with the listings database 130, in one embodiment. For example, information regarding, hours of operation, special visitors, special events could be factored in when providing assimilated responses to requesting users.

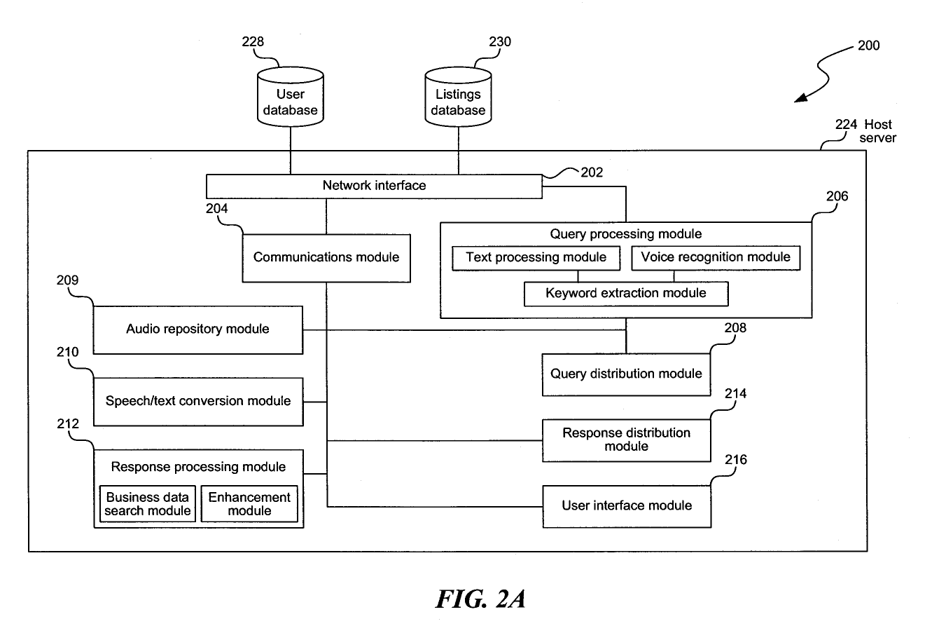

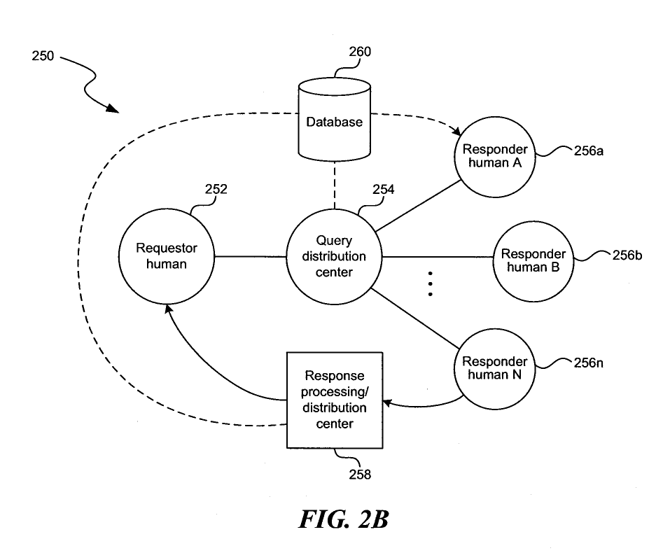

The host server 124, to receive responses to queries from multiple recipient users can establish one or more communication sessions via various protocols, in parallel and/or in series with one or more of subsets of the multiple recipient users. For example, the recipient users may be communicating their responses via different communication channels, including, but not limited to, email, SMS, IM, voice, etc. at similar and/or substantially different times. The host server 124 establishes communications sessions with the recipient user devices as suitable and gathers the set of responses to the distributed query. Further functionalities of the host server are described with further reference to FIG. 2A.

In some embodiments, the host server 124 is coupled to a content server (not shown). The content server represents any system having software agents and/or hardware modules able to provide content that is static and/or dynamic. The content server can be a server provided by online radio networks, including online radio stations, Real Networks, Rhapsody, iTunes, etc. In some embodiments, many content servers may be communicatively coupled to the host server 124. For example, the content server may be systems that host web-sites for business listings. The content server may also be a review-based website (e.g., third-party, community-based, professional, etc.) with user ratings and comments of business listings.

The instant messaging server 126, can establish connections with one or more of the client devices 114A-N through any known and/or convenient protocol, such as, but is not limited to Session Initiation Protocol (SIP), SIP for Instant Messaging and Presence Leveraging Extensions (SIMPLE), Application Exchange (APEX), real time messaging protocol (RTMP), Presence and Instant Messaging Protocol (Prim), Extensible Messaging and Presence Protocol (XMPP), instant messaging and presence protocol (IMPP), Open Mobile Appliance (OMP), Instant Messaging and Presence Service (OMP), etc.

IM service providers that provide the IM services which can be accessed by mobile devices over a wireless network, can include, but are not limited to, AIM, Jabber, EBuddy, Windows Messenger, Yahoo! Messenger, QQ, Skype, Sametime, Xfire, ICQ, Gadu-Gadu, Paltalk, MXit, PSYC, Meebo, etc. The IM server 134 (e.g., a Jabber/XMPP server) can provide and manage one or more of the above mentioned protocols (e.g., SIP, OMP, XMPP) to provide access to the instant messaging network by allowing various IM software clients (e.g., Gabber, Exodus, Google Talk, etc.) to utilize the protocols to provide connectivity to end users (e.g., client devices 106A-106N).

FIG. 2A depicts a block diagram illustrating a system 200 to moderate mobile social networking for query management among a plurality of users, the system 200 to include a host server 224 coupled to a user database 128 and/or a listings database 130, according to one embodiment.

In the example of FIG. 2A, the host server 224 includes a network interface 202, a firewall (not shown), a communications module 204 having a call module, a query processing module 206 having a text processing module and/or a voice recognition module, a query distribution module 208, an audio repository module 209, a speech/text conversion module 210, a response processing module 212, a response distribution module 214, and/or a user interface module 216. The host server 224 may be communicatively coupled to the user database 128 and/or the listings database 130 as illustrated in FIG. 2A. In some embodiments, the user database 128 and/or the listings database 130 are partially or wholly internal to the host server 224.

In the example of FIG. 2A, the network controller 202 can be one or more networking devices that enable the host server 224 to mediate data in a network with an entity that is external to the host server, through any known and/or convenient communications protocol supported by the host and the external entity. The network controller 202 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

A firewall, can, in some embodiments, be included to govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

Other network security functions can be performed or included in the functions of the firewall, can be, for example, but are not limited to, intrusion-prevention, intrusion detection, next-generation firewall, personal firewall, etc. without deviating from the novel art of this disclosure. In some embodiments, the functionalities of the network interface 202 and the firewall are partially or wholly combined and the functions of which can be implemented in any combination of software and/or hardware, in part or in whole.

In the example of FIG. 2A, the host server 224 includes the communications module 204 or a combination of communications modules communicatively coupled to the network interface 202 to manage a one-way, two-way, and/or multi-way communication sessions over a plurality of communications protocols. In one embodiment, the communications module 204 receives data, information, and/or messages over a gateway which converts mobile wireless data to a TCP/IP based message. Therefore, for example, SMS based messages that originate from a portable wireless device is received from a gateway. In one embodiment, the communications module 204 receives information over a gateway which converts data, messages, text, audio data, and/or touch tone dials that originated from a telephone. Similarly, in one embodiment, the communications module 204 receives communications from a network (e.g., Internet) via a web-based chat service (e.g., IM chat).

Since the communications module 204 is typically compatible with receiving and/or interpreting data originating from various communication protocols, the communications module 204 is able to establish parallel and/or serial communication sessions to receive queries from users, to send the queries to selected recipient users, to receive responses from the selected recipient users, and/or to provide one or more enhanced responses to the requesting users.

In addition, requests (e.g. queries) and responses can be provided, received, processed, sent, and/or assimilated in voice and/or text or any combination of such during the different processes of generating moderated enhanced responses in response to a query. For example, a requesting user may generate the query by voice via a portable client device. To provide the query to suitable recipients who prefer, in some instances, to receive requests via different protocols (e.g., SMS text, email, or voice), the audio of the query can be converted to text, if necessary. For example, the voice query may be converted to text before being sent via SMS and the relevant communications protocol established. Recipient users may, in some instances, prefer to receive the queries via a voice call (e.g., recording or live speaker), thus the appropriate communications protocol is established by the communications module 204. Similar processes apply for other forms of communication by way of example but not limitation, email, IRC, instant messaging, USSD messages/commands, etc.

Similarly, recipient users can provide responses (e.g., personalized responses) to queries via one or more communications channels. For example, a recipient user can place a voice call the host server 224 to provide a response to the query. Similarly, recipients can text message (SMS), email, and/or instant message responses back to the host server 224 with the communications module 204 providing the relevant connectivities. In most instances, the communications module 204 sends one or more correspondences (e.g., enhanced responses, personalized responses assimilated with business data, enhanced responses, etc.) back to the requesting user via a requesting user device via the same protocol the query was received, this may be the default setting. Of course, the requesting user may elect to receive suggest enhanced responses via one or more different communications protocols and/or to receive the enhanced responses via one or more same or different user devices that the query was sent from.

Additionally, the requesting user may provide an audio-based (e.g., voice-based, speech-based) query. But to receive the enhanced responses, the requesting user can elect to receive, in addition to a voice call, a text based version of the enhanced responses as well. For example, via SMS and/or email. A requesting user can elect to always send the enhanced responses by SMS text by default or to send the enhanced responses by SMS text only when a voice call is unanswered. In addition, the requesting user may specify for the enhanced responses to be sent to different devices. For example, enhanced responses can be sent via SMS to one portable device and via email to another. In general, the requesting user can select to have responses provided at any time, via any communication channel, and/or to any devices. Additional combinations are contemplated and are considered to be within the scope of the disclosure. The communications module 204, can include, one or more of, or any portion of the one or more of the above described functions, without deviating from the spirit of the novel art of the disclosure

The query processing module 206 is any combination of hardware modules and/or software agents able to receive, retrieve, parse, analyze, and/or process data/information related to intelligent query distribution. The query processing module 206 can, in some embodiments, include a keyword extraction module to perform one or more of the above listed functions. For example, the keyword extraction module can parse a sentence and identify a set of keywords from the sentence. The keywords may be identified based on a comparison with a target set of information, such as, user data (e.g., user information, user metadata, user profile, etc.).

The data/information received may have been received over various protocols and may be in various formats, including, but not limited to, text, audio, speech, image, video, etc. In some embodiments, the data/information is received from the communications module 204. In particular, the query processing module 206 may include a text processing module and/or a voice recognition module to process textual data and speech data, respectively.

For example, test-based queries (e.g., SMS messages, USSD comments) can be managed by the text processing module where further analysis can be performed. Similarly, in one embodiment, data/information gleaned from a string of web-based chat messages (e.g., IM chat, chat room, IRC, forum, web-blog, email, etc.) can be sent to the text processing module for identifying information that pertains, for example, to determining whom the query should be sent to. In particular, the text processing module, in one embodiment, is able to scan the query to detect one or more search parameters.

For example, a search parameter can be identifiable via detecting an indication of a location, a business listing, a time, a day, a type of event, and/or a type of business. In some embodiments, this function is performed by the keyword extraction module via a keyword search. In other embodiments, search parameters are identified via any known and/or convenient manner including but not limited to natural language processing and entity detection. The search parameters, once identified, is, in one embodiment, communicated to the query distribution module 208 to facilitate the distribution process to recipient users, by for example, identifying users more suited than others to respond to a particular query.

The search parameters are typically utilized to search for users, based on user profiles that can potentially provide richer responses to the particular query. The potential recipient users that are more suitable are, in some embodiments, identified based on an indication of correlation between user data and one or more search parameters. For example, a correlation may be a match in a potential recipient's neighborhood of residence and the geographical region of relevant interest to the particular query. In a further example, the query can be for French restaurants and the potential recipient is a French chef. In some embodiments, the indication of correlation is identified based on keyword matches between the user data entries and the search parameters.

In a query submitted, for example, to search for “the best restaurant with great Tuscan wines and mushroom risotto”, search parameters that can be identified include, “wine”, “Tuscan wine”, “risotto”, etc. Thus, a recipient identified as a “wine connoisseur” can, in some instances be identified as a potentially suitable user to respond to the query regarding wine.

In a further embodiment, audio data/information gleaned from a voice-enabled communication session (e.g., phone call, VoIP, IM-chat, etc.) can be relayed to the voice recognition module for identifying the contents of the voice-based query, and, in particular, to detect search parameters, as in text-based queries. For example, a search parameter can be identifiable via detecting an indication of a location, a business listing, a time, a day, a type of event, and/or a type of business. The search parameters, once identified, can, in one embodiment, be communicated to the query distribution module 208 to facilitate the distribution process to recipient users, by for example, identifying users more suited than others to respond to a particular query.

In some embodiments, the voice recognition module can include any number of software and/or hardware components to provide one or more of sound detection functions, audio signal processing functions, speech recognition functions (e.g., automatic speech recognition, computer speech recognition), speech processing functions, voice recognition functions, to facilitate parsing the query and identifying the search parameters. For example, the voice recognition module, may internally include, or be externally coupled to a microphone, such as dynamic microphones, ribbon microphones, condenser microphones, array microphone, or any type of transducer that converts sound into an electrical signal for the purposes of detecting sound. Any number of microphones as suitable depending on the application and/or environment can be used.

The voice recognition module may further include software agents and/or hardware modules for speech recognition, as implemented by any known and/or convenient manner, such as, but is not limited to the Hidden Markov model (HMM)-based speech recognition and dynamic time warping (DTW)-based speech recognition. In other embodiments, the electrical signal representing sound may be sent to another module for sound processing, speech recognition and the like functions.

In some embodiments, the signals representing sound may be processed on the voice recognition module and sent to another module/device for speech recognition and/or voice recognition (e.g., speaker recognition) purposes. Speech processing includes processing of a digital and/or analog signal, and by way of example but is not limited to, enhancement of speech signals (e.g., noise reduction), speech coding (e.g., signal compression, time compressed speech), voice analysis, speech synthesis, etc. The voice recognition module, can include, one or more of, or any portion of the one or more of the above described functions, without deviating from the spirit of the novel art of the disclosure.

In one embodiment, the query distribution module 208 is coupled to the query processing module 206 and/or the user database 128. The query distribution module 208 can be any combination of hardware modules and/or software agents able to assimilate data/information from various sources (e.g., user database 128, query processing module 206) and identify correlations between user data retrieved from the user database 128 and the search parameters determined from queries. In some embodiments, the search parameters are identified by the query processing module 206 for text-based and/or voice-based queries. In an embodiment, a requesting user could select from a list of potential recipient users, and format a message to the selected potential recipient user(s). The query distribution module 208, in this case, may be merged with a typical message sending system (e.g., email client).

The user database 128 can provide information about users participating in the mobile social network, including requesting users and potential recipient users. User information can include, with further reference to FIG. 3A, by way of example but not limitation, user profile information, user ratings/reviews, and/or queries/enhanced responses associated with participating users. User profile information can be, for example, basic user information submitted by a user when signing up for the services. The basic user profile information can include, age, gender, an address, a zip code, and/or a phone number, etc. In some embodiments, the user can optionally submit additional information with their profile, for example, hobbies, interests, favorite cuisines, favorite restaurants, membership/involvement in clubs, etc. Some user profile information can also be identified from the user's wireless service subscription information, such as billing zip codes, area of service, area code, etc.

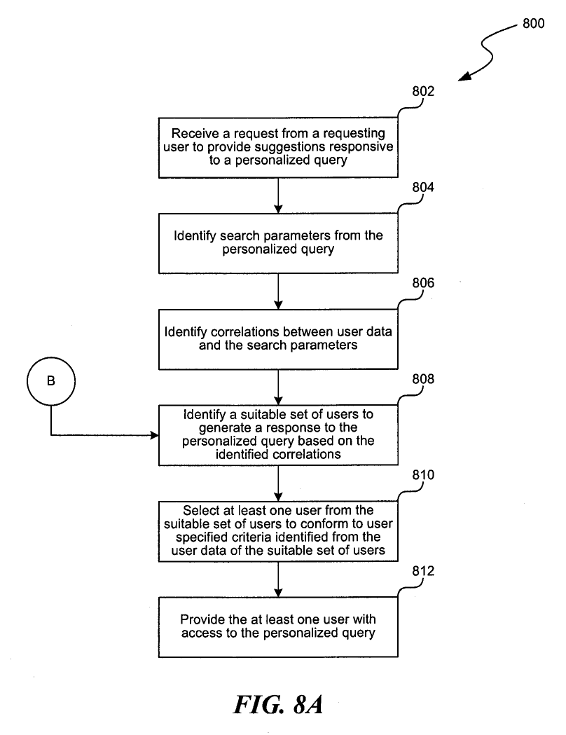

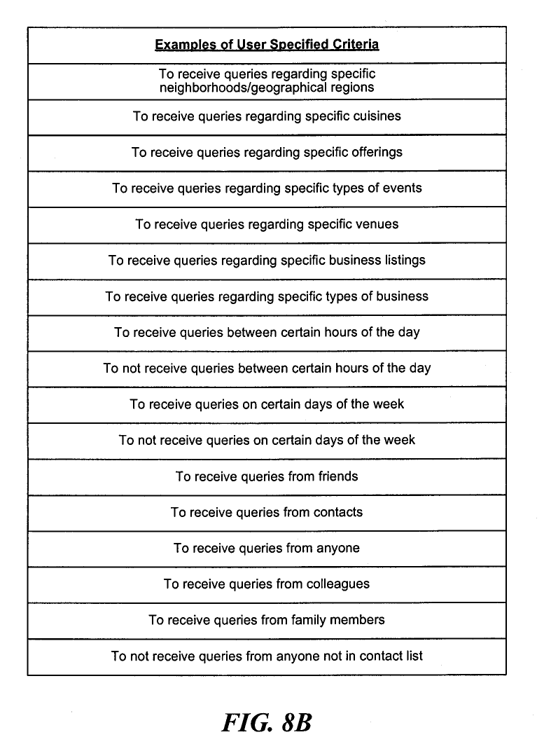

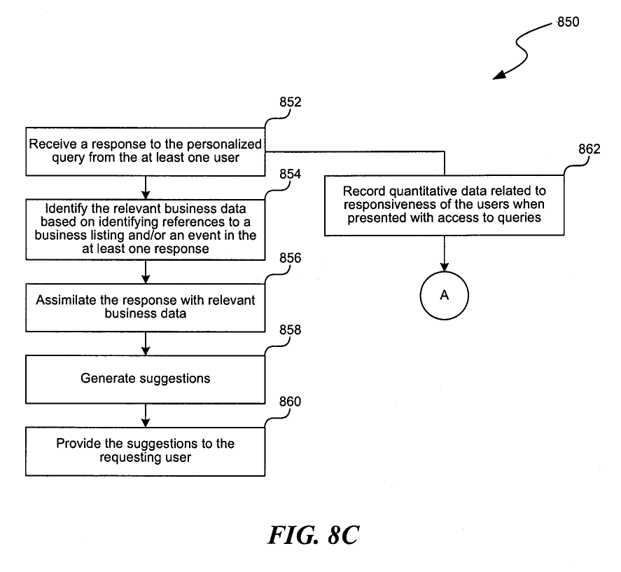

In particular, in some instances, the user profile information includes data about user specified criteria for receiving queries from requesting users. For example, the user may specify to only receive queries from requesting users that are contacts. In a further example, the user may self-proclaim to be an expert in classical jazz and specify to be pinged, in particular, when queries relevant to jazz arise. In some embodiments, specified criteria also include preferences for the time/day that users are open to receiving queries and time/days when the users are not. Additional examples of user specified criteria are listed with further reference to FIG. 8B.

The user ratings/reviews data is typically submitted by other users in the mobile social network. In some situations, the responses (e.g., personalized responses) submitted by users to received queries are accessible to at least some of the mobile social network. Therefore, the community provides a peer-review system for responses provided by participants in the mobile social network. The participants typically include intended recipients of the responses as well as third-party reviewers. In a further embodiment, the user ratings/review data also includes quantitative data about user responsiveness, including but not limited to, rate of response (number of responses submitted by the user: number of queries received by the user), average time to response, etc.

In most instances, quantitative data describing user responsiveness are also factored into selecting potential recipients to receive queries. Specific types of user ratings/reviews data is described in detail with further reference to FIG. 3A. In a further embodiment, the user database includes a plurality of queries and enhanced responses provided to users in response to the plurality of queries, in particular, with further reference to FIG. 3A. With a database storing queries and enhanced responses, in some instances, an enhanced response may automatically provided when a query matching one stored in the database is received.

Therefore, based on the user information (e.g., user data, user metadata, user information, geographical information, subscription information, ratings information, responsiveness data, etc.) that can be retrieved from the user database 128 and search parameters identified from queries, the query distribution module 208 identifies some users that are potentially suitable for responding to the query. As described, the suitability may be identified based on a keyword match between user data and identified search parameters. The keyword match may be a smart keyword match. For example, if a query includes the word “pricey”, the system may be smart enough to match pricey, and other synonyms or similar words or phrases to “expensive.” Similarly, if a user asks about good punk bands, the system may be smart enough to match “punk” to “alternative music.”

In some embodiments, suitability of potential recipients is identified by required time to response. For example, a requesting user who desires to receive a response within the next hour may be suited for a different set of potential respondents than a requesting user desiring a response within the next 6 hours. Based on a tracked average time to response, queries that request a quicker response time can be sent to recipients that tend to respond sooner. Other types of correlation between users data and search parameters include by way of example but not limitation, match between geographical region, zip code, area code, business listing, cuisine, events, etc.

Once one or more suitable recipients have been identified, the query distribution module 208 communicates with the communications module 204 to establish one or more appropriate communications channels with the recipients to relay the query to the recipients' user devices for access. Similarly, when responses (e.g., personalized responses) are received from one or more recipients via the communications module 204, the responses are, in some embodiments, relayed to the response processing module 212 for additional processing, filtering, and/or enhancement.

The response processing module 212 is any combination of hardware modules and/or software agents able to receive user generated responses (personalized responses) to queries and to identify relevant business data associated with the received user generated responses. In some embodiments, the response processing module 212 also generates an enhanced response by assimilating the user generated responses with the identified business data to be provided to requesting users. The response processing module 212 is, in some instances, coupled to the listings database 130. In some embodiments, the response processing module 212 includes a business data search module and/or an enhancement module.

The listings database 130 may be queried to obtain information about business listings. For example, the types of offerings at a place of business (e.g., tea, coffee, dessert, pastries, etc.), the types of activities offered by the business (e.g., roller coasters, miniature golf, late night dining, movie theaters, shopping, video games, etc.), hours of operation, user reviews/ratings, professional ratings, etc. Information about business listings can be obtained from a third-party content host and/or from the business itself (e.g., telephone query and/or web-based query).

For example, the business may sponsor ads or listings on third-party web sites. In addition, information about the business, such as hours of operation, may be obtained from the business web-site. Third-party content hosts that provide business information to consumers include but are not limited to, the yellow pages, web-based peer-review sites (e.g., Yelp.com, Citysearch.com), and/or professional ratings (e.g., Zagat ratings, Wine Spectator.com). In some embodiments, the response processing module 212 communicates with the listings database 130 to identify information about business listings to be assimilated with the responses provided by recipient users. For example, the business data search module can establish a communication session with the databases to identify business data. In some embodiments, the listings database 130 is queried for business listings and/or events listings, such as listings of businesses in specific geographical locations, as identified by area codes and/or zip codes, for example. Listings information include, by way of example, but not limitation to, listings of movie theaters, restaurants, bars, cafes, theme parks, libraries, hotels, etc.

In one embodiment, the response processing module 212 scans the response received from recipient users and detects references to business listings and/or events to facilitate identification of business data relevant to the response. The relevant business data identified from the listing database can include an address, contact information, and/or hours of operation, for example, by the business data search module. In addition, the response processing module can further provide a map with the response to the sent to the requesting user. For example, the enhancement module can communicate with the business data search module to retrieve the relevant business data to be provided with the personalized responses. Additional forms of enhancement data (e.g., business data, maps, calendar event, v-card, etc.) to be provided along with the user response to a query are contemplated and considered to be within the novel art of this disclosure. In one embodiment, the enhancement module performs one or more of the above described functions related to combining the personalized response with business data to generate an enhanced response.

In one embodiment, the response processing module records quantitative data related to responsiveness of recipient users when presented with access to queries. In some embodiments, the response processing module includes a review module to perform quantitative analysis and to record the analysis. The review module may also query users to reviews, comments, and/or ratings about other users/responses submitted by the other users. For example, the quantitative data can include, average time to respond, rate of response, and/or total number of responses. The quantitative data can further be sent to the user database 128 to be stored for future access.

The host server 224 in the example of FIG. 2A, in accordance with one embodiment, further includes the audio repository module 209. The audio repository module 209 can be any combination of hardware modules and/or software agents able to store and/or read audio data, in a variety of formats, including, but not limited to, mp3, mp4, m4a, m4p, aac, wma, ra, wav, ogg, flac, aiff, raw, aw, DVD, CD, Blu-Ray, HD-DVD, DTS-CD, SACD, etc. The audio repository module 209 can be, in some embodiments, accessible by the response processing module 212. For example, audio data (e.g., pre-recordings, synthesized audio tracks, speech, voice, music, etc.) can be retrieved from the audio repository module 209 by the response processing module 212.

The audio track can include, for example, but is not limited to, speech to provide for instructions, prompt users for information, and/or soundtracks for background music. In some embodiments, the audio repository module 209 includes standard voice greetings, voice-based instructions for users of the mobile social network. The audio repository module 209 may further include digital signal processors (DSP) that support generation of digital music files and/or audio effects/mixing.

The speech to text conversion module 210 can be any combination of hardware modules and/or software agents able to convert speech to text and/or vice versa. In some embodiments, the conversion module is able to convert text to speech (e.g., synthesized speech) for transmission over an audio-enabled device (e.g., portable phone, telephone, VoIP, voice-enabled IM chat service, etc.). The conversion module may further be able to synthesize voice according to selected dialects or languages, based on user settings. In addition, the conversion module 210 can include speech recognition functions to convert speech data into text-based data to be presented to users for example, via SMS and/or web-based chat services.

The response distribution module 214 can be any combination of hardware modules and/or software agents able to provide the machine-enhanced/moderated user responses to the requesting user that submitted the query. Depending on the communication channel established with a user, the response distribution module 214 can communicate with the conversion module 210 to obtain audio data and/or text data to be provided to the users. In some embodiments, the machine-enhanced user responses are provided in a format based on user specified settings. For example, a user may with to receive the responses via email in addition to a voice call/SMS text. These settings are in most embodiments, user configurable, for individual sessions, for a predetermine amount of time, defaulted, and/or context specific.

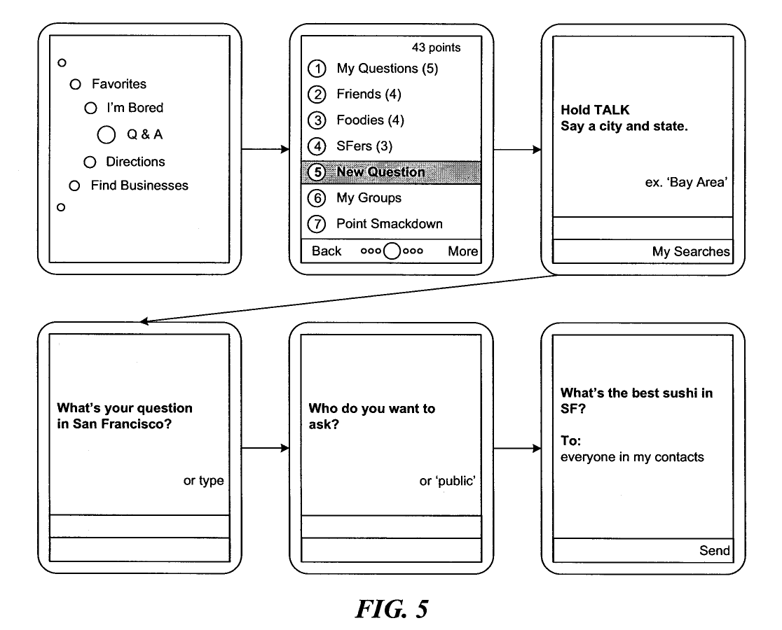

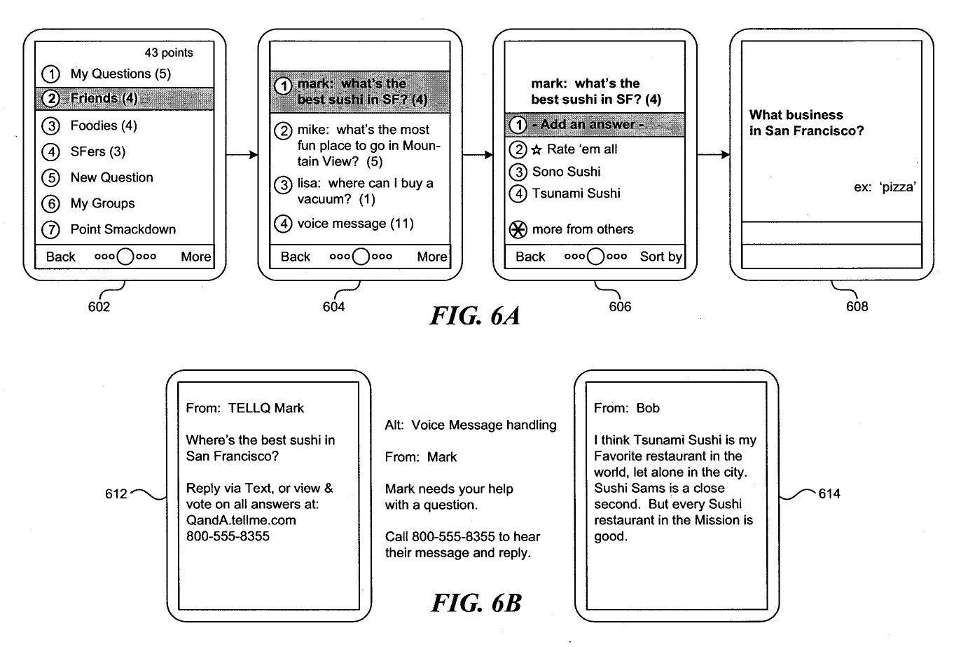

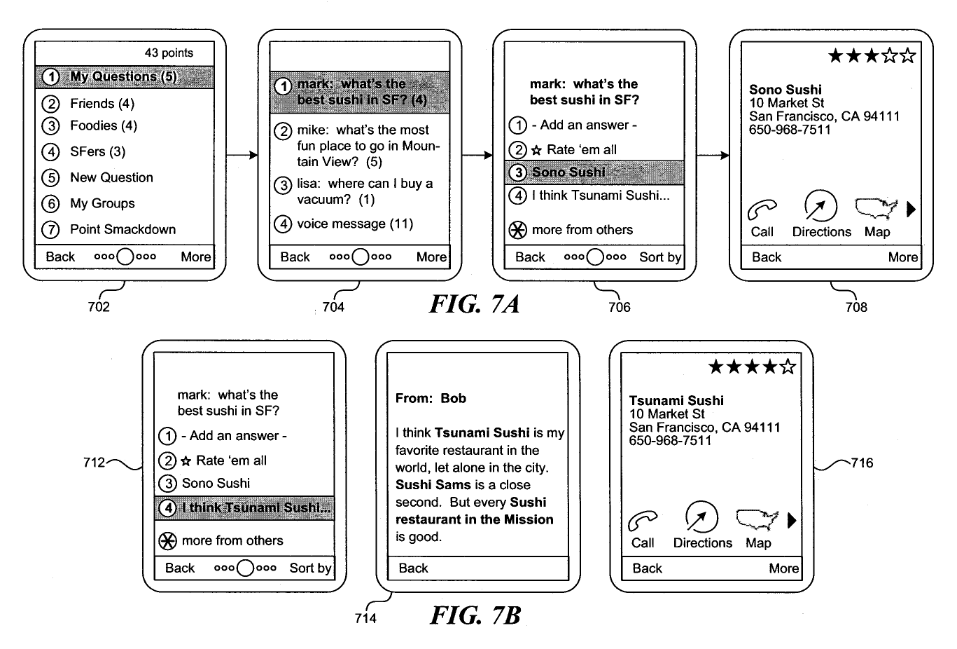

The user interface module 216 can be any combination of hardware modules and/or software agents able to provide a customized user interface for users to submit queries, to manage their queries, to provide responses to queries submitted by other users and/or to view/manage responses received from other users. In some embodiments, the user interface module provides a user interface to access additional functions and/or services as well, for example, other wireless services, web-based services, and/or services related to mobile social networking with other users. Examples of user interfaces provided by the user interface module 216 as well as services accessible via the user interfaces can be visualized with further reference to the example user interfaces of screenshots of FIG. 5, FIG. 6A, and/or FIG. 7.

The host server 224 can be implemented using one or more processing units, such as server computers, UNIX workstations, personal computers, and/or other types of computes and processing devices. In the example of FIG. 2A, the host server 224 includes multiple components coupled to one another and each component is illustrated as being individual and distinct. However, in some embodiments, some or all of the components, and/or the functions represented by each of the components can be combined in any convenient and/or known manner. For example, the components of the host server may be implemented on a single computer, multiple computers, and/or in a distributed fashion.

Thus, the components of the host server 224 are functional units that may be divided over multiple computers and/or processing units. Furthermore, the functions represented by the devices can be implemented individually or in any combination thereof, in hardware, software, or a combination of hardware and software. Different and additional hardware modules and/or software agents may be included in the host server 224 without deviating from the spirit of the disclosure.

FIG. 2B is a diagrammatic view 250 illustrating the progression of a query into a response among varying entities in a mobile social networking environment, according to one embodiment.

When a requestor human 252 generates a question (e.g., query), the question can be sent to a query distribution center 254 via any known and/or convenient communications channel. Typically, the requestor human 252 sends the question while he/she is on-the-go and thus, many questions received by the query distribution center 254 are sent from a portable device (e.g., cell phone, Blackberry, Treo, iPhone, etc.), although exceptions can and do exist.

The query distribution center 254 receives the questions via any known and/or convenient communications channel. The question can also be in any format, including but not limited to text and/or audio form (e.g., speech, voice, touch tones, etc.). The query distribution center 254, regardless of the format of the question, parses the question (e.g., query) generated by the requestor human 252 and identifies the aspects of the question (e.g., search parameters) that would deem it suitable for some users to answer rather than others. The aspect, oftentimes parts of the question, are compared to user data gleaned from, for example, user profiles in the database 260 to identify users that possess the knowledge to potentially provide useful responses to the requestor human 252.

A number of responder humans can be registered with the system (e.g., responder humans A-N). The query distribution center 254, can in some embodiments, identify one or more responder humans from the registered responder humans suitable to answer the question submitted by the requestor human 252. Any number of responder humans can be selected. The number of responder humans selected can be configured to a default number, session-specific, user-specified, and/or context dependent (e.g., automatically adjustable or user-specified). In some embodiments, additional criteria are utilized in addition to user knowledge to select the responder humans to respond to the requestor human's 252 question. For example, reviews of the responder humans and promptness to respond of responder humans can additionally be accounted for in the selection of responder humans to receive a question submitted by the requester human 252. Further description regarding the selection of responder humans is provided with further references to FIG. 2A and FIG. 8-9.

When one or more responder humans 256 have received the question they can choose to respond to the question or not. When an answer (e.g., response, personalized response, etc.) has been submitted by at least one human responder, via one or more user devices via any communications modes, the response processing/distribution center 258 again parses the answer to detect references to business listings and/or events listings, for example. Once references to business listings and/or events listings have been identified, the response processing/distribution center 258 can identify, for example, from the database 260, business data relevant to the business listings and/or events listings identified from answers submitted from the human responders.

Once business data information has been identified, the response processing/distribution center 258 provides enhanced responses including the answer (personalized answers and/or personalized response) and the business data to the requester human 252. Similarly, the enhanced responses can be provided to any number of user devices via any communications channel. The enhanced responses can be, based on user configuration, provided to the requestor human 252 on demand, at predetermined time intervals, or immediately when ready. Enhanced responses are, in some embodiments, provided to the requester human 252 when ready by default without adjustments to the configuration.

FIG. 3A depicts a block diagram illustrating a user database 328 to store user profiles 328A, user ratings/reviews 328B, and/or queries/enhanced responses 328C, according to one embodiment.

In the example of FIG. 3A, the database 328A can store user profile data (e.g., user data, user metadata, user information, etc.), including user information of the service subscribers of wireless services and/or service subscribers of the mobile social network, and/or any other user information provided by the user. For example, user profile data can include descriptive data of personal information such as, but is not limited to, a first name and last name of the user, a valid email ID, a unique user name, age, marital status, occupation, location, education, home town, schools attended, number of siblings, heritage, ethnicity, race, etc. The user information further includes interest information, which may include, but is not limited to, activities, hobbies, professional information, photos, etc.

In one embodiment, user profile data stored in database 328A is explicitly specified by the user. For example, when the user (e.g., visitor/service subscriber) signs up for wireless services, telephone services, and/or IM services, a set of information may be required, such as a valid email address, an address of service, a valid credit card number, social security number, a username, and/or age. User profile data can also be implicitly specified or automatically extracted from a process. For example, if a sender or answerer's location is auto-detected via GPS, the detection can be used to figure out to whom to send questions (e.g., someone proximate).

The user information form can include optional entries, by way of example but not limitation, location, activity, hobbies, ethnicity, photos, etc. Examples of user profile data include those shown in 328A, including, but is not limited to, user name, age group, contact information (e.g., phone #, screen name, email address, etc.), preferred mode of contact, available hours, metro area of residence, neighborhood of residence, address of residence, frequent/familiar areas of travel/business, top restaurants, favorite cuisines, top activities, favorite hobbies, community involvement/social group memberships, etc.

The database 328 can also store user ratings and review data 328B. User ratings/review data can either be explicitly submitted by users or provided via one or more software agents and/or hardware modules coupled to the user ratings/reviews database 328B. For example, a user can periodically submit comments/ratings for responses that the users have received. The user can also submit comments/ratings for responses provided to other users, for example, comments on general quality of the responses. Similarly, quality of user reviews can be automatically determined and stored in the database. For example, quantitative data related to responsiveness of users can be tracked, calculated, and/or measured such that the quantitative measures can be stored in the database 328B.

Examples of user data stored in the user ratings and review database include those shown in 328B, user data such as, but is not limited to, rating of quality of response by other users, comments by other users about usefulness of enhanced responses, average time to response, response rate, queries submitted by user, enhanced responses provided by user, enhanced responses received by user, and/or ratings/comments submitted for other users.

It may be desirable to allow users to “opt in” to hearing expert answers to a particular question. For example, a user may request a good local pizza restaurant, but also be curious about what other people say about this question, and opt in to receive the replies.

In one embodiment, the user database 328 further includes a user queries/enhanced responses database 328C. The user queries/enhanced responses data is typically compiled via one or more software agents and/or hardware modules coupled to the user queries/enhanced responses database 328C, for example, the response processing module and/or the query processing module. Examples of user data stored in the user queries/enhanced responses database 328C include user data such as, but is not limited to, queries submitted by users for a particular locale/neighborhood, enhanced responses provided by users for a particular type of business, enhanced responses provided by users for a particular locale/neighborhood, enhanced responses provided by users for a particular cuisine, rating of enhanced responses provided by users, comment on enhanced responses provided by users, and/or top queries (e.g., top 10 queries), etc.

FIG. 3B depicts a block diagram illustrating a listings database 330 to store business listings 330A and/or events listings 330B, according to one embodiment.

In the example of FIG. 3B, the business listings database 330A stores information (e.g., data, metadata, profiles, etc.) regarding business listings, including, but not limited to, yellow page information, businesses in a locale based on zip codes and/or area codes, contact information of businesses, hours of operation, average cost for a meal. For example, business listing data can include descriptive data of business listing information such as, but is not limited to, name of business listing, type of business, type of offerings, price ranges, menus, hours of operation, movies showing, hotels in a particular locale, amenities offered at a hotel, type of art displayed, etc. In one embodiment, business listings content stored in database 330A can be maintained and managed by the business itself or a third-party content manager.

Examples of business listings content (e.g., data, metadata, profiles, etc.) stored can include those shown in 330A, restaurant listings, theatre listings, opera house listings, concert venue listings, bar listings, dry cleaner's listings, museum listings, nightlife listings, and/or miniature golf listings, etc. The database 330 can also store events listings, for example, in database 330B, events listings information can either be directly maintained by business entities or by third-party content managers. Examples of data stored in the events listings database 330B can include, but are not limited to, jazz events listings, dance festivals, arts & crafts festivals, farmers' market listings, carnivals, food festivals, and/or marathons.

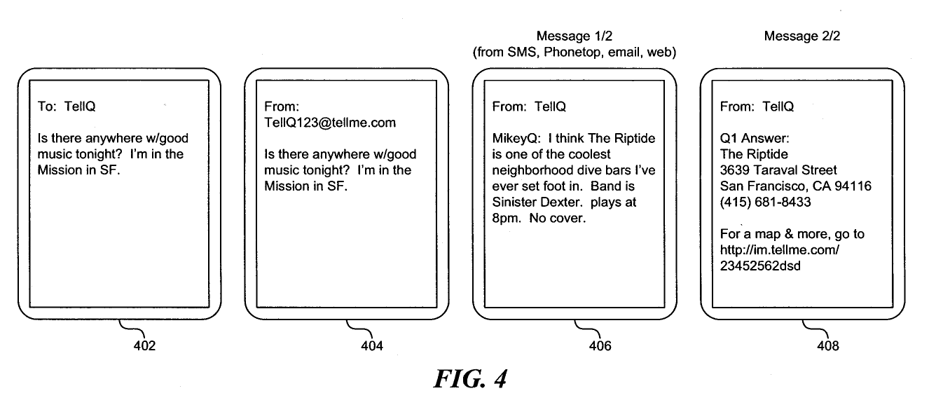

FIG. 4 illustrates example user interfaces for a portable device user to submit a query via SMS and to receive a machine-moderated human response, according to one embodiment.

User interface 402 is an example of a user interface screen displayed on a mobile device for sending a query via SMS text. In the example of FIG. 4, the user interfaces allows a user to send a query in an SMS message to a predetermined address to be routed to another user. As shown, the requesting user compiles a text message in screen 402 by sending a text message to ‘TellQ’ and requests a location specific event. (“Is there anywhere w/good music tonight? I'm in the Mission in SF.”). The agent, can, in some embodiments refine the search results by making queries, either predetermined or on a case-by-case basis.

In the example shown in the user interface 404, the query is sent as an SMS text to a recipient user ‘MikeyQ’. In other embodiments, the recipient user receives the query via other communication modes. The recipient user ‘MikeyQ’ can provide a response via replying to the SMS text. In some embodiments, the recipient user response via one or more of other communication modes.

The examples of user interface 406 and 408, the response received by the requesting user is provided in two SMS text messages. In the user interface 406, the response (personalized response) provided by the recipient user ‘MikeyQ’ is displayed. (“MikeyQ: I think the Riptide is one of the coolest neighborhood dive bars I've ever set food in.” Band is Sinister Dexter, plays at 8 pm. No cover.”). In the user interface 408, business data that is relevant to the response provided by the recipient user ‘MikeyQ’ is sent to the user via SMS text as well. In one embodiment, the business data is automatically identified by the system based on the response provided by the recipient user ‘MikeyQ’. In this example, the system identified the business listing ‘The Riptide’ and provided the address and phone number of the listing (“The Riptide 3639 Taraval Street, San Francisco, Calif. 94116, (415) 681-8443”) to enhance the personalized response. In further embodiments, additional information can be obtained and provided to the user, for example, information about the band (‘Sinister Dexter’), a play list, etc.

FIG. 5 illustrates a series of example user interfaces for a portable device user to submit a query and to specify the audience to direct the query to, according to one embodiment.

The example screenshot 502 is typically displayed on, for example, portable devices such as cell phones. The screenshot can be a user interface launched by running customized software agents on the portable device. In the user interface of screenshot 502, provides the user access to various services, including, for example, ‘favorites’, ‘I'm bored’, ‘Q&A’, ‘Directions’, ‘Find Businesses’, etc. In the example screenshot 504, the user can select to submit a new question (“New Question”). When a user selects to enter a new question (e.g., option 5), the user interface of screenshot 506 prompts the user to say a city and state to which the question is relevant to. In this particular example, the user is prompted to say the city and state. In alternate embodiments, the geographical location (e.g., city and state) can be submitted via text entries and/or touch tones.

As shown in the example user interface of screenshot 508, the system has identified that the user is interested in asking a question regarding the San Francisco region. Once the user has submitted the question via voice and/or text, in the user interface of screenshot 510, the user is prompted for a desired audience, in accordance with one embodiment of the present disclosure. A voice-based prompt can be presented in addition to or in lieu of the text-based prompt In this example, the user wishes to ask his/her contacts. In the example user interface of screenshot 512, the list of recipients and the question (e.g., query) is displayed to the user. In some embodiments, the user can make final modifications to the question, if necessary. Once the question has been finalized, the user can send the question to the select set of users.

FIG. 6A illustrates a series of example user interfaces for a portable device user to submit a recommendations in response to a query, according to one embodiment.

The series of example user interfaces are, in some embodiments, launched when a customized software agent is running on a user device (e.g., portable device). The customized software agent can be displayed on a number of types of user devices including but not limited to, desktop computers, laptop computers, cell phones, Treos, iPhones, Blackberries, etc. In the example of FIG. 6A, the user interface 602 can be used to access a number of services and functions, including access to queries submitted by others. For example, in the screenshot 602, the user can select to view correspondences received from friends.

In the user interface of screenshot 604, the user is able to view a question received from a number of friends. In particular, the user selects to view the question submitted by user ‘Mark’ (“Mark: what's the best sushi in SF?”). Once this question entry has been selected, as shown in the example user interface of screenshot 606, the user is presented with the options to, for example, ‘add an answer’, ‘Rate 'em all’, and/or view the other answers, for example, an answer labeled ‘Sono Sushi’ and another answer labeled ‘Tsunami Sushi’. In the example shown, the user selects to add an answer (Option 1). Thus, in the user interface of screenshot 608, the user is prompted for the name of the business in San Francisco. Audio-based prompt may be presented in addition to or in lieu of the text-based prompt. The entry can, in many embodiments, be submitted, in text, voice, and/or touch tones.

FIG. 6B illustrates a series of example user interfaces for a portable device user to provide recommendations in response to a query via SMS, according to one embodiment.

Queries, in addition to being delivered to devices having installed upon it, customized software, can also be delivered to devices (e.g., portable and/or non-portable) without the customized software. In the example shown, the same query provided by user ‘Mark’ is also sent as a SMS text message to user ‘Bob’ via a portable device, as shown in screenshot 612. In some embodiments, the user ‘Bob’ has the option of submitting the response (e.g., personalized response) via replying to the text message. In other embodiments, the user ‘Bob’ can submit the response via other communication modes such as, voice dial, IM, IRC, web-interface submission, etc. In addition, the user is presented with the options to view and/or vote on answers that have been submitted at a predetermined web URL (“QandA.tellme.com”). In alternate embodiments, other methods of viewing and/or voting (otherwise reviewing, commenting, ratings, etc.) are contemplated and are considered within the novel art of the disclosure

In one embodiment, the text message includes a predetermined phone number for the user ‘Bob’ to call to submit a response (e.g., personalized response) to the question submitted by user ‘Mark’. The example user interface of screenshot 614 illustrates how the response submitted via text can be displayed on the requesting user's device. The response (“I think Tsunami Sushi is my Favorite restaurant in the world, let alone in the city. Sushi Sams is a close second. But every Sushi restaurant in the Mission is good.”), in this example, is displayed as a text message indicating the sender's identity.

FIG. 7A illustrates a series of example user interfaces for a portable device user to access and view the moderated enhanced responses provided in response to a query submitted by the portable device user, according to one embodiment.

In one embodiment, the requesting user accesses the user interface provided by a customized software agent to view the answers (e.g., personalized responses and/or enhanced responses) received in response to a submitted question (e.g., query). In the example user interface of screenshot 702, the user selects to view submitted questions and/or to see the answers provided by other users. In screenshot 704, the user selects to view the question submitted by the user ‘Mark’ (option 1). In screenshot 706, the user now selects to view a response (“Sono Sushi”) submitted in response to the question submitted by user ‘Mark’ (option 3), for example.

In screenshot 708, the business listing information associated with “Sono Sushi”, including an address and a contact phone number is presented to the user. In some embodiments, the user interface allows the user to directly map the location. In addition, the user can access directions to the listing and/or call the listing via icons displayed on the example user interface of screenshot 708.

FIG. 7B illustrates a series of example user interfaces for a portable device user to access and view the moderated enhanced responses provided in response to a query submitted by the portable device user, according to one embodiment.

In the example user interface of screenshot 712, the user selects to view a different response to user Mark's question. The user now selects to view the response (e.g., personalized responses and/or enhanced responses) associated with option 4. In the example user interface of screenshot 714, the response from user ‘Bob’ is displayed on the screen (“I think Tsunami Sushi is my Favorite restaurant in the world, let alone in the city. Sushi Sams is a close second. But every Sushi restaurant in the Mission is good”). In some embodiments, parameters identified in responses provided by users are highlighted in the display. In this example, the text in the listing ‘Tsunami Sushi’ is highlighted in the display. In addition, the user interface of screenshot 716 presents to the user, business data that is relevant to the user response (personalized response).

In this example, the business listing information is provided in conjunction with the response from ‘Bob’. As shown in screenshot 716, the business data can include, in some embodiments, the address for the business listing and the contact telephone number for the business listing. In other embodiments, additional types of business specific information can be included, by way of example but not limitation, contact email, contact IM, fax number, hours of operation, special events, etc. In addition, the user can, via the icons of the user interface, access a map of the location and/or direction to the business.

FIG. 8A depicts a flow diagram 800 illustrating a process of providing a query to a recipient to respond to the query, according to one embodiment.

In process 802, a request is received from a requesting user to provide enhanced responses responsive to a query. In most instances, the request is generated by the requesting user via a portable device, for example, a portable device with a wireless connection. The request can be sent via a number of communications channels, including but not limited to, email, SMS text, USSD messages, voice call, touch tones, voice messages, instant messaging, IRC, etc. Typically, a query refers to a question and/or query regarding specific human experiences with particular business and/or events that is intended to be directed towards a human audience. For example, a query could be, one that searches for the spiciest salsa on the peninsula, the quickest pizza delivery, the ice cream shop with mint chocolate chip ice cream with the most chocolate bits, etc.

In process 804, search parameters are identified from the query. Search parameters can be identified from the query, typically to determine the users that can potentially provide a useful response to the query. Search parameters are oftentimes identified by detection of types of cuisine, types of business, specific business listings, a location, a geographical region, a time of day, etc. For example, a query including the text “spiciest salsa on the peninsula” can be identified as having search parameters, Mexican cuisine, Peninsula, etc. Therefore, a user that lives on the Peninsula can be identified as being potentially able to provide useful responses (e.g., personalized responses).

In process 806, correlations between user data and the search parameters are identified. In some embodiments, correlations between user data and search parameters are determined based on keyword matches. User data typically includes, but is not limited to, user profile information retrieved from user databases. User data can also include information regarding quality of user responses (e.g., personalized responses) from a qualitative and/or quantitative perspective. For example, users of the network can view, rate, and/or comment on others' responses to queries. Requesting users that receive responses (e.g., personalized responses and/or enhanced responses) to queries can also submit ratings and/or comments.

In process 808, a suitable set of users to generate a personalized response to the query is identified based on the identified correlations. In some embodiments, the system records compute and/or records quantitative data to determine how responsive a user is and how quick a user typically is to response. The quality of a user's response can, in some embodiments, be factored into the query distribution process. For example, if a user chronically provides irrelevant or un-thoughtful responses to queries, the user may not be asked to provide responses anymore. In some embodiments, quantitative data regarding a user's responsiveness (how soon a user responds, the number of responses versus the number of queries received, etc.) is factored into the query distribution process.

Therefore, based on identified correlation between user data and search parameters (e.g., the correlations typically being merit-based correlations indicating how knowledgeable a user is to response to a particular query) and quality of a user's participation (e.g., qualitative factors including reviews, comments, ratings, and quantitative factors including measures of responsiveness), a set of users deemed suitable to provide an insightful response to the particular query is identified. In some embodiments, the query can be provided to the full set of users. In other embodiments, the set of users is further narrowed down based on additional criteria to whom to distribute the particular query.

In process 810, at least one user is selected from the suitable set of users to conform to user specified criteria identified from the user data of the suitable set of users. Some examples of user specified criteria related to receiving personal queries from other user are listed with further reference to table 820 of FIG. 8B. User specified criteria can include location specific criteria, business/event specific criteria, time-based criteria, and/or user specific criteria. For example, potential responders may not wish to receive queries during certain times of the day. In addition, potential responders may specify to only receive queries from people in the potential responders' contact list. Based on these criteria, which are in some embodiments, included in the user data, the suitable set of users can further be narrowed down.

In process 812, the at least one user is provided with access to the query. Based on user profile information, quality of response, and, in some embodiments, user specified criteria; at least one user from the suitable set of users is identified. The query can be distributed to the at least one user via one or more communications channels. The communications channel can be user specifiable, for example, some users may wish to receive queries via SMS text rather than a voice call. The user can specify a preferred email address for receiving queries from others. In addition, users can specify the devices they wish queries from other users to be sent to, for example, if a user has multiple devices registered with the system (e.g., a laptop computer and a cell phone).

FIG. 8C depicts a flow diagram 850 illustrating a process of providing enhanced responses to a requesting user, according to one embodiment.

In process 852, a response (personalized response) to the query is received from the at least one user. The query can be received via, one or more of many communications channels and devices. A user may wish to receive queries on both a portable device and on a desktop computer, for example. Queries can be received from, SMS text, emails, voice calls, voice mails, instant messaging, IRC, USSD messages, etc. In some embodiments, the user can specify how the query is presented. For example, the query can be presented to the user automatically upon receipt or the presence of the query can be indicated to the user.

Once the user has reviewed the query, the user may respond to the query via the one or more communications channels. Typically the user responds via the same communications channel that the query was received from. In other embodiments, different communications modes and/or devices are used for responding to a query and receiving a query.

In process 854, the relevant business data is identified based on identifying references to a business listing and/or an event in the at least one response.

In one embodiment, when a response to a query is received from a responder, the response (e.g., personalized response) is scanned for information useful for locating business data relevant to the response. In some embodiments, references to specific business listings and/or events in a response are typically useful indicators for identifying business data. For example, if a response includes a reference to “Outback steak house in San Jose”, detailed business listing information including hours of operation, location, contact information, can be identified in association with the received response. Relevant business listing information can typically be identified in listings databases, for example.

In process 856, an enhanced response is generated by assimilation of the response (personalized response) with relevant business data. In some embodiments, the response provided by a user is assimilated with the identified business data (e.g., directions, hours, contact information, location, etc.) to be presented to the requesting user. In some embodiments, calendar events, maps, v-cards, Evites, a schedule of performances, a listing of special events at a particular venue, a listing of offerings, and/or any other information/data files deemed useful can be provided to the requesting user along with the response as the enhanced response. In process 858, an enhanced response is generated from the received response and the additional business data in one or more forms.

In process 860, the enhanced responses are provided to the requesting user. The enhanced responses can similarly be provided to the requesting user in one or more of many communications channels. The communications channel can be selected based on default setting or user specified setting. Multiple communications can be selected by the user. In addition, the user can configure the settings to have the enhanced responses delivered to multiple devices.

In process 862, quantitative data related to responsiveness of the users when presented with access to queries is recorded. As described, quantitative data regarding responsiveness of users when responding to queries can be tracked, measured, computed, and/or recorded. The quantitative measures ensure, facilitate, a sense of responsibility and participation in the community such that the quality of the service can be controlled and maintained. Quantitative data include, by way of example but not limitation, how soon a person responds when a query has been sent to them, how frequently a person responds, total volume of responses generated, etc. In some embodiments, an award system rewards and/or incentivizes users to generate useful responses in a timely fashion.

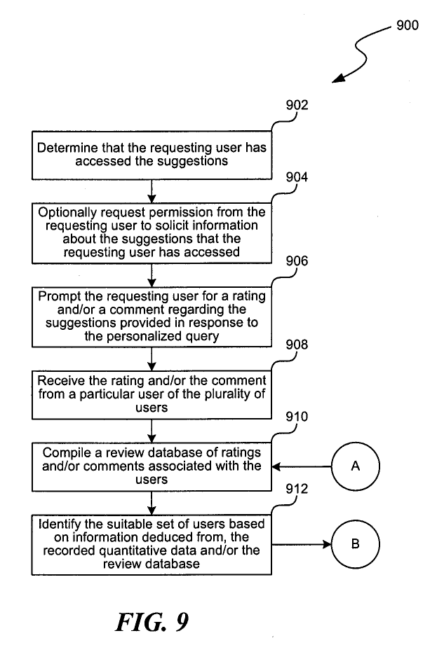

FIG. 9 depicts a flow diagram 900 illustrating a process of a community-based peer review system for responses to queries, according to one embodiment.

In process 902, the system determines that the requesting user has accessed the enhanced responses provided. Requesting users that have received enhanced responses from other users are a source for gauging general success of the mobile social network and for determining user satisfaction, either with the system and/or with the responses to the queries. In process 904, permission is optionally requested from the requesting user to solicit information about the enhanced responses that the requesting user has accessed. In some embodiments, information is solicited about user satisfaction with the service, such as questions about general usability, user-friendliness, helpfulness, promptness, ease of access, etc.

In process 906, the requesting user is prompted for a rating and/or a comment regarding the enhanced responses provided in response to the query. In one embodiment, the requesting user is provided a form to be submitted regarding the response they received. In some embodiments, the requesting user can submit comments/ratings via a web-interface. Similarly, the requesting user can provide comments and/or critiques via a number of communications channels, by way of example but not limitation, sending a text message to a predetermined phone number, sending an email to a predetermined address, placing a voice call, leaving a voice message, etc.

In process 908, the rating and/or the comment is received from a particular user of the plurality of users. In addition to obtaining user satisfaction information from requesting users, other users in the network can, in some embodiments, view the responses provided by others as well. Since some users possess more expertise regarding certain businesses, locales, and/or types of events, a checks-and-balances system exists and, in most instances, motivates users to provide quality information and prevents users from submitting inaccurate information.

In process 910, a review database of ratings and/or comments associated with the users is compiled. Based on comments, critiques, ratings, and/or reviews provided by requesting users and/or other users, a review database of users and the ratings they have received from other users can be compiled. In a further embodiment, quantitative data that describe user responsiveness is recorded in the review database as well.

In process 912, the suitable set of users is identified based on information deduced from, the recorded quantitative data and/or the review database. Sine the review database includes a wealth of information regarding user behavior in the mobile social network of providing responses to queries, the review database is typically probed when identifying suitable users for responding to a particular query. In addition to user profiles which provide information regarding how knowledgeable a person is to add insight to a response of a particular query, information about user behavior is typically determined to assist in the process of identifying users to provide responses to the particular query.

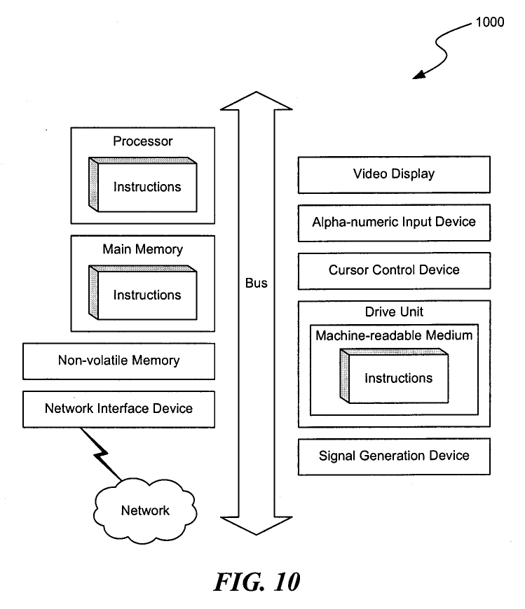

FIG. 10 shows a diagrammatic representation of a machine in the example form of a computer system 1000 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a web appliance, a network router, switch or bridge, or any machine capable of executing a set of instructions (sequential or otherwise) that specify actions to be taken by that machine.

While the machine-readable medium is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine or computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

Although embodiments have been described with reference to specific example embodiments, it will be evident that the various modification and changes can be made to these embodiments. Accordingly, the specification and drawings are to be regarded in an illustrative sense rather than in a restrictive sense. The foregoing specification provides a description with reference to specific exemplary embodiments. It will be evident that various modifications may be made thereto without departing from the broader spirit and scope as set forth in the following claims. The specification and drawings are, accordingly, to be regarded in an illustrative sense rather than a restrictive sense.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

I/We claim:

1. A method, comprising:
receiving a request from a requesting user to provide a response to a query,
extracting at least one search parameter from the query;
identifying a suitable set of users from a plurality of users to generate a personalized response to the query, the suitable set of users to be determined based on an indication of correlation between user data of the suitable set of users and one or more of the at least one search parameter;
providing at least one user of the suitable set of users with access to the query, the at least one user to be selected from the suitable set of users to conform with user specified criteria identified from the user data of the suitable set of users;
in response to receiving at least one personalized response to the query from the at least one user of the set of users, generating one or more enhanced responses by enhancing the one or more of at least one personalized response with relevant business data;
providing the one or more enhanced responses to the requesting user.

2. The method of claim 1, wherein the request from the requesting user is generated from a portable device.

3. The method of claim 1, wherein the at least one search parameter is identifiable via detection of an indication of one or more of a location, a business listing, a time, and a type of business

4. The method of claim 1, wherein the indication of correlation is identifiable based on a keyword match between metadata of the user data and the one or more of the at least one search parameter.

5. The method of claim 1, wherein a user of the suitable set of users is deemed suitable based on one or more of proximity to a geographical region to which the query is relevant and specialized knowledge for a type of business for which the query is relevant.

6. The method of claim 1, further comprising identifying the relevant business data based on identifying a reference to one or more of a business listing and an event in the at least one personalized response.

7. The method of claim 1, further comprising identifying the relevant business data based on identifying a reference to one or more of a business listing and an event in the at least one personalized response; wherein the relevant business data comprises relevant business data of one or more of the business listing and the event, the relevant business data to include at least one of, an address, contact information, and hours of operation.

8. The method of claim 1, further comprising, recording quantitative data related to responsiveness of the plurality of users when presented with access to queries.

9. The method of claim 1, further comprising, recording quantitative data related to responsiveness of the plurality of users when presented with access to queries; wherein the quantitative data comprises one or more of, average time to respond, rate of response, and total number of responses.

10. The method of claim 1, further comprising, a method of a peer review system, the peer review method comprising:
determining that the requesting user has accessed the one or more enhanced responses;
optionally requesting permission from the requesting user to solicit information about the one or more enhanced responses that the requesting user has accessed;
prompting the requesting user for at least one of a rating and a comment regarding the one or more enhanced responses provided in response to the query.

11. The method of claim 10, further comprising, receiving the at least one of the rating and the comment from a particular user of the plurality of users;
wherein the particular user of the plurality of users provides the at least one of the rating and the comment upon reviewing a particular personalized response of a plurality personalized responses submitted by another user of the plurality of users.

12. The method of claim 10, further comprising, compiling a review database of ratings and comments associated with the plurality of users.

13. The method of claim 12, further comprising, identifying the suitable set of users based on information deduced from, one or more of the recorded quantitative data and the review database.

14. A system, comprising:
a communications module to communicate with one or more user devices; wherein, in operation, the communications module to process a user query received from the one or more user devices;
a user database to store user data;
a listings database to store at least one of business listing data and events listing data;
a keyword extraction module to extract a set of search parameters from the user query;
a query distribution module communicatively coupled with the keyword extraction module, the user database, and the content database, the query distribution module to identify a suitable set of users from a plurality of users to generate a human response to the user query;
wherein, in operation, the query distribution module communicates with the communications module to distribute the user query to at least one user of the suitable set of users;
a response processing module communicatively coupled with the listings database to retrieve relevant business data from the listings database;
wherein, in operation, the response processing module generates one or more enhanced responses by enhancing one or more of the human responses provided by one or more of the at least one user of the suitable set of users by assimilating the human responses with the relevant business data.

15. The system of claim 14, further comprising a query processing module communicatively coupled to the communications module and the keyword extraction module; wherein, when in operation, the query processing module identifies the set of search parameters from the user query via one or more of voice recognition and text recognition to process the user query received from the one or more user devices.

16. The system of claim 14, further comprising a speech and text converting module to perform one or more of a converting speech to text and text to speech.

17. A method, comprising:
receiving a query from a requesting user,
extracting at least one search parameter from the query;
comparing the at least one search parameter with user metadata of a plurality of users;
identifying a set of users of the plurality of users deemed suitable to generate a personalized response to the query;
wherein the set of users are identified based on an indication of correlation between the user metadata of the set of users and one or more of the at least one search parameter.

18. The method of claim 17, wherein the at least one search parameter is identifiable via detection of an indication of one or more of a location, a business listing, a time, and a type of business in the query.

19. The method of claim 17, wherein the indication of correlation is identifiable based on a keyword match between the user metadata and the one or more of the at least one search parameter.

20. The method of claim 17, wherein a user of the set of users is deemed suitable based on one or more of proximity to a geographical region to which the query is relevant and specialized knowledge for a type of business for which the query is relevant.
